(19) United States
(12) Patent Application Publication
(10) Pub. No.: US 2002/0095308 A1
(43) Pub. Date: Jul. 18, 2002

(54) System and method for facilitating shipment transaction creation and monitoring

(76) Inventors: John Pragelas, Montreal (CA); Stephen J. DiLorenzo, Scarsdale, NY (US)

Correspondence Address: Accu-Star Systems Inc., Suite 400, 75 Port Royal St. East, Montreal, QC, H3L 3T1, CA

(21) Appl. No.: 09/997,000

(22) Filed: Nov. 30, 2001

(30) Foreign Application Priority Data
Dec. 1, 2000 (CA) 2327210

(51) Int. Cl. G06F 17/60

(52) U.S. Cl. 705/1

(57) ABSTRACT

A central server that facilitates and tracks shipping transactions, such as transactions in which a sending party or source organization wishes to have a shipment of goods transported to a delivery site or destination organization using a carrier. The source party wishing to ship goods may initiate a transaction. The various documents which need to be created in a shipping transaction (e.g., a bill of lading (“BOL”) or proof of delivery (“POD”) document) may be created and stored at the central server, which allows one or more of the parties to the transaction to view the documents as the status of the transaction changes. The vehicle transporting the shipment may be tracked by, for example, a global positioning system (“GPS”) system, and the location of the vehicle, before or after picking up the goods, may be tracked by one or more of the parties.

### FIELD OF THE INVENTION

The present invention relates to facilitating and monitoring shipments and to tracking the location of vehicles utilized therefor; more specifically, the present invention relates to a centralized, network-based system and method allowing the various parties involved in a shipping transaction to enter into, monitor and carry out the transaction and monitor the shipment.

### BACKGROUND INFORMATION

Generally, several parties may participate in a transaction whereby a vehicle is used for shipment of goods. For example, a supplier of merchandise wishes to have goods shipped to a receiver, which in some cases may be the direct consignee. The supplier may also wish to have goods shipped from one supplier location to a second supplier location. A storage facility such as a warehouse which is not owned by or affiliated with the supplier may store the goods prior to shipment. The supplier or consignee hires a carrier or other transporter such as a trucking company to ship the goods. The carrier or other transporter transports the goods, typically using a vehicle such as a tractor trailer truck. The carrier or other transporter may ship the goods from a supplier site or a non-supplier warehouse to another supplier site, a consignee (e.g., a receiving party not associated with a supplier), or a warehouse not associated with the supplier or the consignee. A carrier typically owns, operates or is associated with a fleet of vehicles used for shipping, and the size of such a fleet may range from one or a handful of vehicles to hundreds or thousands. However, a carrier may be a third party freight forwarder, which does not own or operate its own vehicles, but rather hires other carriers to ship goods.

A supplier which is continually shipping thousands of different loads of goods from various supplier locations or warehouses to various receivers, or other supplier locations or warehouses, typically finds it desirable to enter into and conduct shipping transactions easily and quickly and to monitor the status of the transaction. Similarly, carriers and consignees wish to arrange and complete shipping transactions conveniently, and track the progress of those shipments—e.g., the progress of a truck to the supplier's warehouse, then to the consignee.

A carrier typically is not paid by the supplier or consignee which hired the carrier until a proof of delivery (“POD”) document is delivered to the hiring party. The POD document is customarily signed by the consignee upon delivery of the goods. Since the POD document is typically a paper document which must be sent to the hiring party, the carrier may not be paid for the shipping job until long after the goods are received by the consignee; thus, in order for a carrier to obtain prompt payment for a shipping job, the carrier gives the POD document to a factoring party, which gives the carrier prompt but discounted payment and which obtains full payment from the hiring party at a later date. Furthermore, delays in shipping paperwork may delay payment in exchange for the goods shipped.

It would be advantageous to have a system and method which allows the parties in a shipping transaction to enter into, monitor, and carry out the transaction expeditiously, with a minimum of delay and paperwork. It would further be advantageous for such parties to be able to track the progress of a vehicle or goods throughout the shipping transaction. It would also be advantageous to have a system and method which allows a carrier or other transporter, or other party in a shipping transaction, to receive faster payment without the requirement for use of a factor, etc.

### OBJECTS OF THE INVENTION

Accordingly, it is an object of the present invention to provide a system and method which enable certain of the parties in a shipping transaction to enter into, monitor, and carry out the transaction expeditiously, with a minimum of delay and paperwork.

A further object of the present invention is to provide a system and method enabling certain of such parties to track the progress of a vehicle or goods throughout the shipping transaction.

Yet another object of the present invention is to provide a system and method enabling a carrier in a shipping transaction to receive faster payment, and to allow other parties, such as those expecting payment in exchange for the goods shipped, to receive faster payment.

Still other objects and advantages of the invention will be apparent or obvious from the specification.

### SUMMARY OF THE INVENTION

The system and method of the present invention advantageously provide a central function for (1) facilitating shipping transactions, such as transactions where a sending party or source organization wishes to send a shipment of goods to a delivery site or destination organization using a carrier (the term “carrier” as used herein concerning our invention shall mean a carrier or any other transporting entity), (2) monitoring the shipping transaction as it proceeds, and (3) generating an electronic POD document or other electronic POD information. Thus, in a typical instance when a transaction is initiated various documents pertaining to it (e.g., a bill of lading (“BOL”) or POD document) can be generated and stored at a central server, such that each of the parties to the transaction can conveniently create a record of the transaction, and moreover can access and view the documents thereby to monitor the status of the transaction as it changes. Further, the vehicle transporting the shipment can be tracked by, for example, a global positioning system (“GPS”) system, and the location of the vehicle, before or after picking up the goods, followed by the parties, thus providing yet another way to monitor the transaction and further to generate an authoritative POD document or other authoritative POD information which can serve as a basis for releasing payment to one or more participants in the transaction. As used herein concerning the invention, the term “vehicle” includes a tractor trailer truck, but may also include other types of vehicles or containers used to deliver goods, such as vans, ships, aircraft, or ocean going or rail going containers. Enabling a party to create and execute documents for a shipping transaction via a central location simplifies such a transaction, results in greater efficiency and leads to quicker settlements for the parties.

According to one embodiment of the present invention, a system is provided for facilitating a multi party shipping transaction, the transaction involving transport by a vehicle of a load of goods from a first facility to a second facility on behalf of a party in interest (the term “party in interest” shall include a sending party, source organization or other entity having ownership or control of goods in need of transport from one facility to another), the system including, inter alia: a central site connected to an electronic network, the central site including a database, the database including, inter alia, a sending party record, a receiving party record, and a shipping party record, the central site capable of collecting location information regarding a load of goods, creating a bill of lading for the load of goods, making available the location information for access by at least one of said parties via the electronic network, making available the bill of lading for access by at least one of said parties via the electronic network, and collecting proof of delivery information.

According to another embodiment of the present invention, a method is provided for facilitating a multi party shipping transaction via a central site, the transaction involving transport by a vehicle of a load of goods from a first facility to a second facility on behalf of a party in interest, the method including, inter alia: collecting at the central site information transmitted from the vehicle describing the location of the vehicle; permitting the first facility to have access to, via the central site, information describing the location of the vehicle; creating an electronic bill of lading; collecting pickup notification at the central site once the vehicle receives the load from the first facility; collecting proof of delivery information at the central site once the vehicle delivers the load to the delivery site; and permitting said party in interest to have access, via the central site, to information concerning the location of the vehicle, to the status of collection of said pickup notification, and to the status of the collection of said proof of delivery information.

According to another embodiment of the present invention, a method is provided for facilitating the transportation of a load of goods by a vehicle between a first facility and a second facility, the method including, inter alia: transmitting from the vehicle information describing the location of the vehicle for posting at a central site; presenting the vehicle at the first facility pursuant to notification, related to the location of said vehicle, that the load of goods awaits pick-up there; after pick-up of the load of goods by said vehicle, transmitting from the vehicle information describing the location of the vehicle for posting at the central site, from which information regarding an estimated time of arrival of the vehicle at said second facility can be determined; securing proof of delivery information, signifying delivery of the load of goods at the second facility, the proof of delivery information being in electronic form suitable for transmission to the central site for posting; and obtaining payment for transport of the load of goods based on the proof of delivery information posted at said central site.

According to another embodiment of the present invention, a method is provided for facilitating the transfer of a load of goods from a first facility to a second facility, the method including, inter alia: accessing a central site presenting information concerning a the location of vehicles available for transporting the load of goods; transmitting to the central site information describing the transfer; transmitting information resulting in the notification of one or more of the vehicles that it should pick up said load of goods at said first facility; after pick-up of the load of goods by the vehicle, accessing the central site to obtain information concerning the location of the vehicle to monitor when delivery of the load of goods will occur; and accessing the central site for proof of delivery information posted at said site concerning said load of goods.

According to another embodiment of the present invention, a method is provided for facilitating the receipt at a second facility of a load of goods from a first facility, the method including, inter alia: accessing a central site for information concerning the location of a vehicle carrying said load of goods; coordinating preparation to receive the load of goods at said second facility with the arrival of said vehicle as indicated by the information; and providing proof of delivery information in electronic form for collection at the central site.

### BRIEF DESCRIPTION OF THE DRAWINGS

FIG. 1 illustrates an embodiment of a shipment processing system according to the present invention.

FIG. 2 illustrates a portion of a vehicle containing certain components of the shipment processing system of FIG. 1 in accordance with the present invention.

FIG. 3 illustrates a vehicle-borne terminal of the shipment processing system of FIG. 1 in accordance with the present invention.

FIG. 4a is a portion of a flowchart illustrating a method of operating the shipment processing system of FIG. 1 in accordance with the present invention.

FIG. 4b is a portion of a flowchart illustrating a method of operating the shipment processing system of FIG. 1 in accordance with the present invention.

FIG. 4c is a portion of a flowchart illustrating a method of operating the shipment processing system of FIG. 1 in accordance with the present invention.

### DETAILED DESCRIPTION OF CERTAIN PREFERRED EMBODIMENTS OF THE INVENTION

In the following disclosure, the present invention will be described in greater depth. For purposes of explanation, specific configurations and details are set forth in order to provide a thorough understanding of the present invention. However, it will also be apparent to one skilled in the art that the present invention can be practiced without t he adhering to those specific details, either omitting or varying them as long as the essence of the present invention is not lost.

The present invention has general applicability to shipping transactions such as transactions in which a source entity sends a shipment of goods to a destination entity using a carrier, where the goods are initially at a goods source location such as a warehouse. Though often the source entity is a supplier and the destination entity is a consignee, the source and destination entities are more broadly any individuals, companies, facilities, business units or sub-units, or other transaction participants (whether or not un-affiliated with each other) wishing to exchange goods. For instance, the destination entity can be a consignee having no relationship to the source entity, a warehouse associated with or hired by any of the parties in the transaction, or a facility affiliated with the source entity. Depending on the transaction, the source and destination entities may be connected with the same party, such as in the case where a company wishes to ship goods between different sites it owns, leases or somehow controls. Further, a separate goods source location (e.g., a warehouse) need not be involved, such as in the case that the carrier is to pick up and/or drop off directly from or to the sending or receiving party.

In certain good embodiments, the system of the invention comprises a centralized shipping transaction processor, a set of data terminals each configured to communicate with at least the shipping transaction processor via a network; and an on-board information manager arranged on a vehicle, wherein the information manager is adapted to communicate with at least the centralized shipping transaction processor throughout the course of a transaction.

In further certain good embodiments, the method of the invention comprises electronically generating a bill of lading, such that the bill of lading can be accessed by the parties to the transaction; electronically notifying a storage facility of a sending party's instruction that an outgoing load be released from the facility for delivery; electronically notifying a carrier that the load is available for pickup; collecting information about the order throughout the course of the transaction; electronically capturing a consignee's acceptance of the delivery; and making the information about the order electronically accessible by the parties throughout course of the transaction.

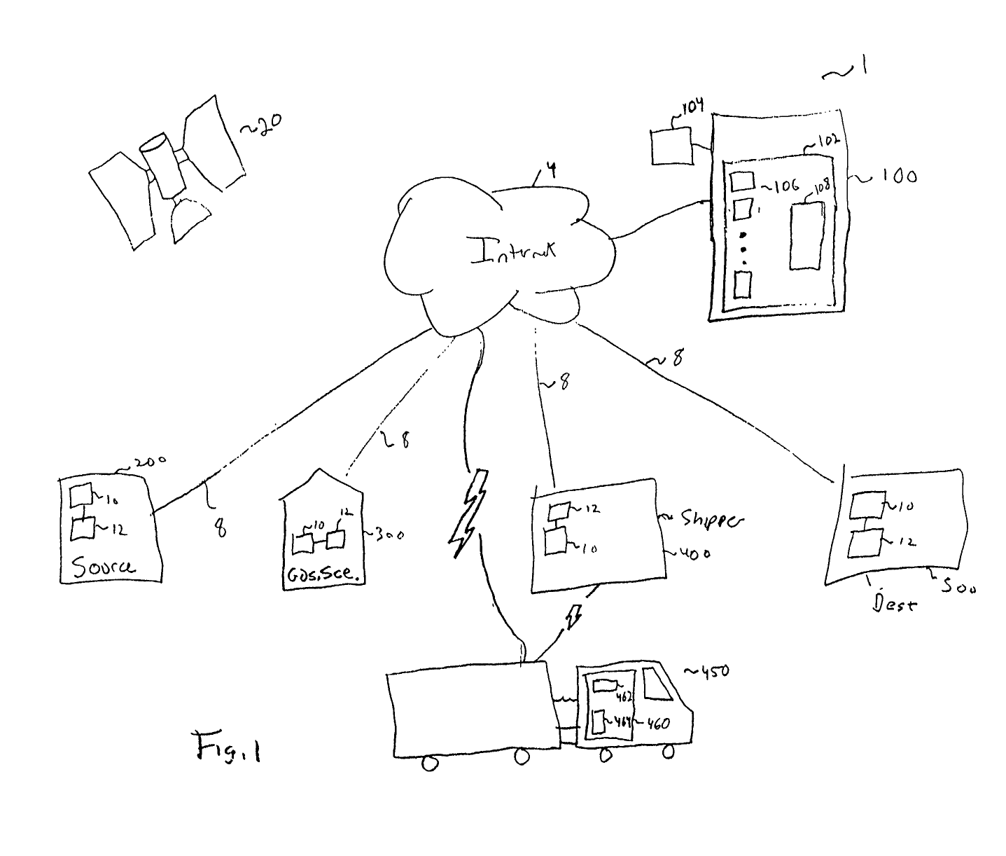

Referring to FIG. 1, the system 1 includes a central server 100, organizing and facilitating shipment transactions, tracking freight loads, and communicating with the various parties involved in shipment transactions. Multiple central servers 100 can be used and a central server 100 can be distributed over more than one site or facility, if necessary as advantageous though this is not shown for the sake of simplicity. Each central server 100 includes one or more databases 102, storing, inter alia, a plurality of user records or accounts 106, transaction information 108, and other information of interest. A Web server 104, connected to or included in the central server 100, provides a user interface, preferably based on a Web site. The central server 100 preferably includes one or more computing devices, such as servers, including known components such as central processing units (“CPUs”), memories, and mass storage devices.

The central server 100 communicates with a plurality of sources 200, a plurality of storage facilities or other goods source locations 300, a plurality of carriers 400, and a plurality of delivery sites or other destinations 500. Each carrier 400 owns, controls, operates, is associated with or otherwise has access to one or more vehicles 450; a carrier 400 may control numerous vehicles 450, or possibly only one vehicle 450. However, a carrier 400 can be a third party freight forwarder, which does not own or operate its own vehicles, but rather hires other carriers 400 to actually ship goods. Both the carrier 400 and the central server 100 can communicate with each one or more of vehicles 450. Each carrier 400 preferably has one or more offices.

The destinations 500 be any parties wishing to receive shipped goods, in accordance with the discussion heretofore. Correspondingly, the sources 200 can be any parties wishing to ship goods, again in accordance with the discussion heretofore. The goods source locations 300 can be any site for storing goods, such as a warehouse or other storage facility, and may be owned by or otherwise affiliated with a source 200 or destination 500.

Either the source 200 or destination 500 can be a party which initiates a transaction using the central server 100. In the case that a freight carrier among carriers 400 is hired by a source 200, destination 500 or another party, the freight carrier may initiate a transaction using the central server 100 where one of carriers 400 is hired to ship a load of goods.

Preferably, the central server 100 is generic, in that it is not geared or dedicated to a certain organization, such as a particular trucking organization. Furthermore, one embodiment of the present invention is order-centric, focusing on the shipment transaction, rather than focusing on one of the parties, such as the carrier or destination entity.

Preferably, the Internet 4, or a similar public or private electronic communications network, provides connectivity among the central server 100, sources 200, goods source locations 300, carriers 400, destinations 500, and possibly vehicles 450. Each of source 200, goods source location 300, carrier 400, and destination 500 is equipped with a terminal 10 allowing a user to access the central server 100. Each terminal 10 can be, for example, a personal computer of known construction, or alternatively another sort of data terminal, such as a personal digital assistant. Associated with each terminal 10 can be a printer 12 for printing reports, receipts and forms. Preferably, each source 200, goods source location 300, carrier 400, and destination 500 is equipped with a communications link 8 which enables the terminal 10 associated with the site to communicate with the central server 100 via, for example, the Internet 4. Such a communications link 8 can be, for example, a telephone/modem connection, a T1 line connection, or a satellite connection. Preferably, communication between the parties to the transaction and the central server 100 is conducted in a secure and encrypted manner. Such encryption methods are well known.

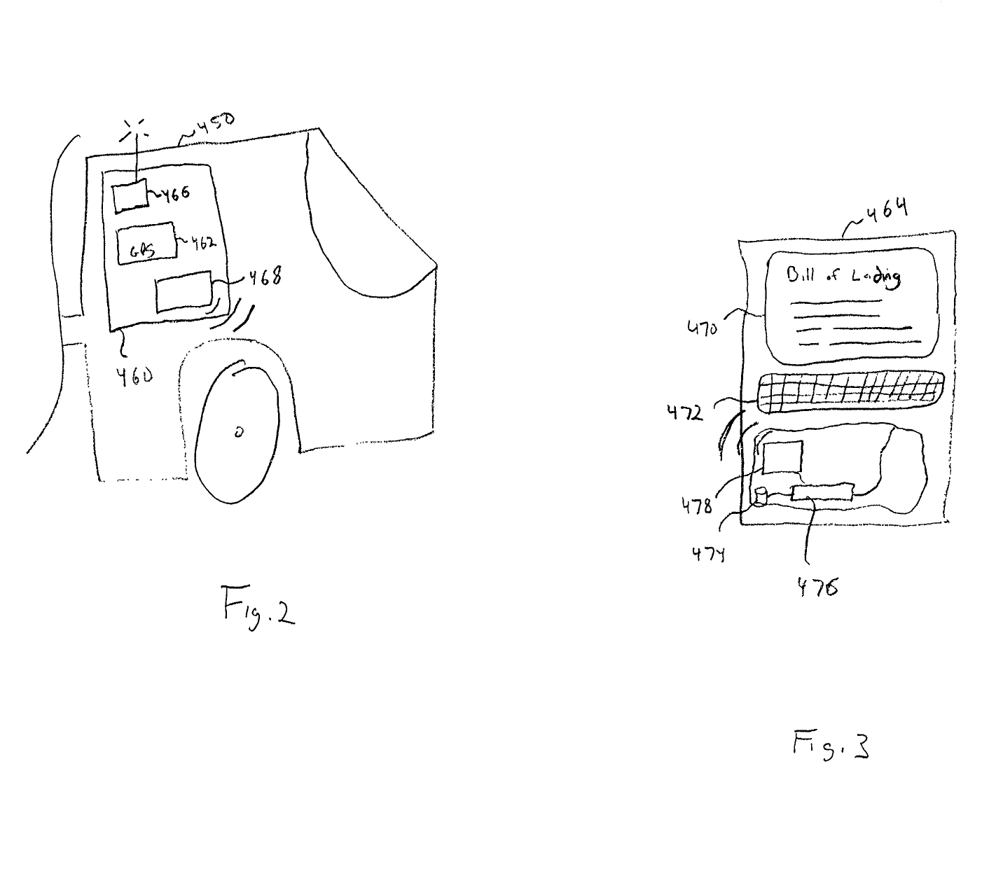

FIG. 2 illustrates a portion of a vehicle of the shipment tracking system of FIG. 1 according to an advantageous embodiment of the present invention. Referring to FIGS. 1 and 2, each vehicle 450 includes a vehicle processor 460 for, inter alia, determining the position of the vehicle 450 and communicating with the central server 100. Preferably, the vehicle processor 460 includes a detachable and portable vehicle terminal 464, allowing a user to access the central server 100. Vehicle operators (e.g., drivers) operating vehicles 450 can communicate with sources 200, goods source locations 300, carriers 400, and destinations 500 via text or other messaging using the vehicle terminal 464 and the central server 100, or alternately by radio (e.g., citizens band radio or inter-organization radio link), cellular telephone, or other methods, such as the public switched telephone network (“PSTN”).

In further embodiment, the vehicle processor 460 includes a network communications unit 466, which advantageously is a cellular transceiver. A vehicle processor 460 accesses the central server 100 via the Internet 4, and preferably access the Internet 4 by the network communications unit 466, through known methods. In alternate embodiments, the vehicle processor 460 can access the Internet 4 through a combination of methods, where each method is the least expensive and/or most convenient to use given the location of the vehicle terminal 464. For example, a combination of a cellular connection, land line connection (e.g., the PSTN), and a satellite radio connection can be used. Preferably, the vehicle processor 460 includes a GPS unit 462 which communicates with one or more GPS satellites 20 to determine the position of the vehicle 450. It is known to use GPS units to communicate with GPS satellites to determine a geographic position. In alternate embodiments, other positioning methods can be used, such as a system comprising ground based beacons.

Advantageously, the vehicle processor 460 includes a communications link 468 (preferably wireless), for allowing the vehicle terminal 464 to communicate with the vehicle processor 460 through known methods. The communications link 468 can be a known wireless link, such as a link adhering to the Bluetooth technology specification for short range radio.

In alternate embodiments, the configuration of and functions of the vehicle terminal 464 and the vehicle processor 460 can differ. For example, the communications link 468 may be of another configuration, such as a cable, or the vehicle processor 460 and vehicle terminal 464 can be one unit, which may be portable or fixed in the vehicle 450.

FIG. 3 illustrates a vehicle terminal of the shipment tracking system of FIG. 1 according to an advantageous embodiment of the present invention. Referring to FIGS. 2 and 3, the preferably removable and portable vehicle terminal 464 provides user interface to the central server 100. In FIG. 3 the vehicle terminal 464 is shown partially cut open to reveal internal components. Preferably, the vehicle terminal 464 is portable and can be separated from the vehicle processor 460; especially preferably it is a hand held unit. The vehicle terminal 464 includes a display 470, a data entry interface 472, a portable power supply such as a battery 474, and a processor 476. The display 470 can be, for example, a flat screen display or an LED or LCD display. Processor 476 can include known components, such as a CPU (e.g., a microprocessor), and a memory (not shown for the sake of simplicity). The vehicle terminal 464 includes a wireless communications link 478 communicating with the wireless communications link 468 of the vehicle processor 460, for allowing the vehicle terminal 464 to communicate with the vehicle processor 460. In an advantageous embodiment, the data entry interface 472 includes a keyboard including a numeric keypad, a number of control keys, and optionally a full alphanumeric keyboard. In a further embodiment, the data entry interface 472 can include a known handwriting entry or signature capture interface. Preferably, during operation, the vehicle terminal 464 displays data and allows the input of data which is transmitted to and received from the central server 100 via the vehicle processor 460.

By way of example, each party wishing to communicate interactively with the central server 100 accesses it via a Web browser based user interface tool (e.g., the Netscape™ Navigator™) which displays a Web site generated by the Web server 104. Such a Web site, or a version of such a Web site, can be displayed on each terminal 10 and on each vehicle terminal 464. Preferably, each terminal 10 and vehicle terminal 464 include software enabling the terminal 10 or vehicle terminal 464 to display a Web site, whether a full version of the Web site as is commonly displayed on personal computers, or a reduced version of the Web site as can be displayed on, for example, personal digital assistants. Such software preferably includes HTML capabilities. Allowing communications, data display, and data entry between a remote client site and a central server via a Web site or other interface generated by a central server and displayed by a remote client site is well known in the art.

Preferably, for each party communicating with the central server 100 using the central server Web site, an account exists in the user accounts 106, such a user account including a user identification (“ID”), a password, and user profile information such as a user name, a user address, and other information. To access and communicate interactively with the central server 100 a party uses its user ID and password to log on to a Web site generated by the Web server 104. Typically, to obtain a user account, user ID and password, a party must register with the central server 100. Additional account information can be stored, for example, inclusion of an address book of other parties commonly dealt with; e.g., contact information for carriers of carriers 400 with which a source entity commonly deals with.

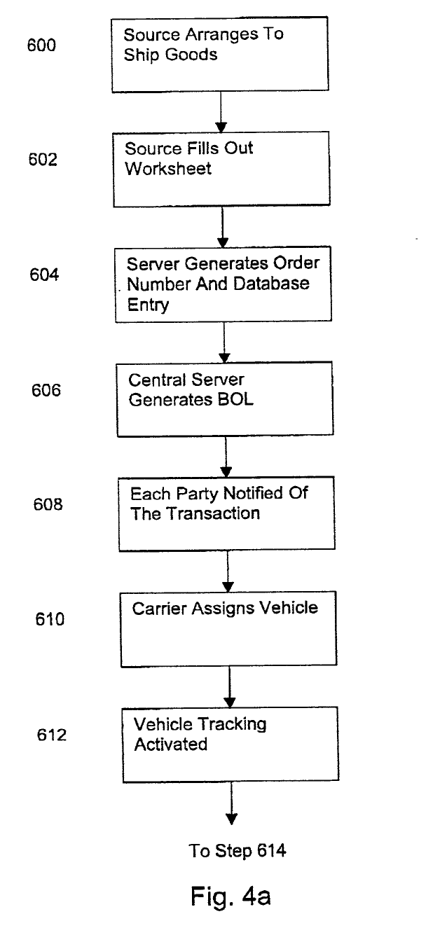

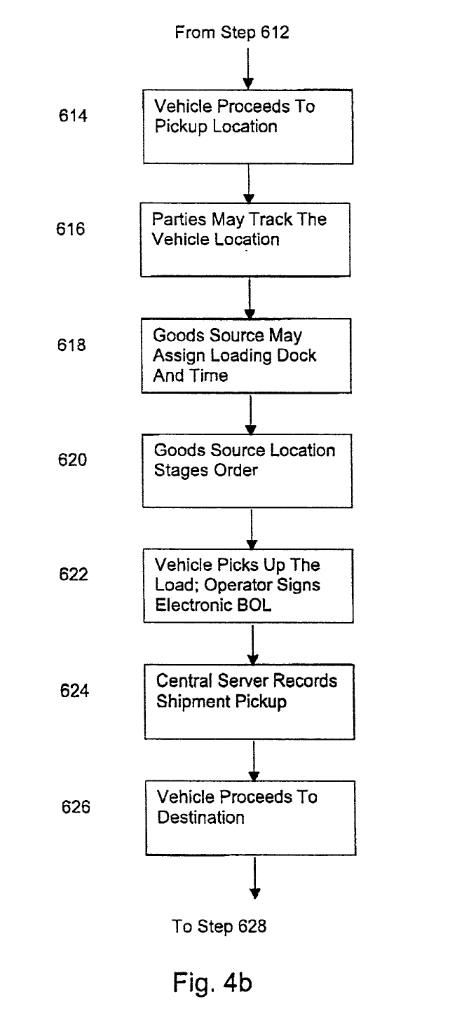

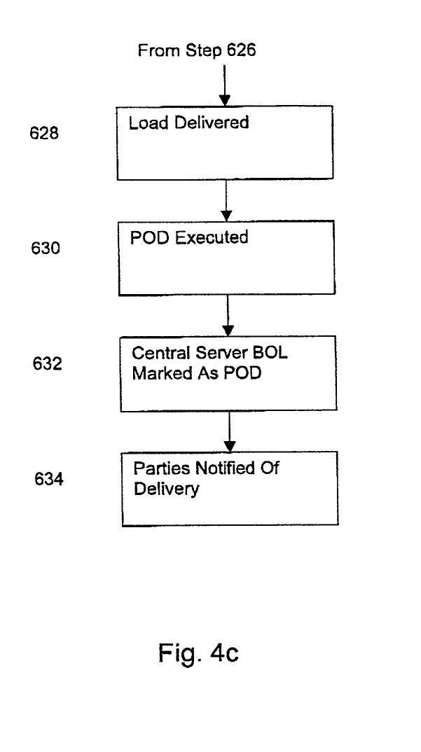

FIGS. 4a, 4b and 4c depict a flowchart illustrating a method of operating the shipment tracking system of FIG. 1 according to an embodiment of the present invention. Referring to FIGS. 4a, 4b and 4c, in step 600, to ship a load of goods from an organization which is a source 200 to a destination 500, a source 200 first arranges with a carrier 400 to ship the load of goods from the source 200 or a goods source location 300 to a destination 500. This can be performed via known methods. For example, a supplier can contact a carrier 400 by telephone, facsimile, or e-mail to arrange for a pick up and shipment. The source 200 and carrier 400 may arrange for a shipment using an on-line (e.g., Internet based Web site) shipment arrangement service. In alternate embodiments, such a service can be included in the functionality provided by the central server 100. For example, the central server 100 may provide a clearinghouse whereby carriers 400 can offer shipping services and sources 200 may accept such services. Such a system may be integrated with the vehicle location capabilities of the system and method of the present invention so that the location of each of the set of vehicles 450 controlled by a carrier 400 may be displayed by the Web site of the central server 100 along with the offer itself, allowing a source 200 to choose the most conveniently located vehicle 450 for a transaction.

In step 602, after the source 200 and carrier 400 arrange for a pick-up and delivery, the source 200 logs on to the central server 100 using its terminal 10 and fills out an on-line source worksheet. To fill out the worksheet, the source 200 enters information about the transaction such as the identity of the carrier 400, a description of the goods, including quantity and weight information, the goods source location 300, and the destination 500. Advantageously, the information entered is that required for a BOL. In alternate embodiments, other information can be entered. In order for the central server 100 to properly identify the carrier 400, vehicle 450, goods source location 300, destination 500, and any other party involved in the transaction (such as an intermediate or third party warehouse), the source 200 preferably either uses the user ID of the party or selects the party from a list provided by the central server 100. The source 200 can be presented with a list of possible parties from which it selects the correct party. For example, the source 200 can be presented with a list of the names of carriers 400 registered with the central server 100 which are in the address book for the source 200; such information is stored in the databases 102. If a party, such as the destination 500, is not registered with the central server 100, the source 200 can enter the name and address of that party.

In an alternate embodiment entry of transaction information is performed completely or partially automatically. For example, a legacy system located at the source 200 transmits transaction information to the central server 100 in lieu of or augmenting an on-line worksheet.

In step 604, the central server 100 generates a unique order number or transaction number for this transaction which may be used by any of the parties to track the transaction, and creates a database entry in the transaction information 108 portion of the databases 102. This database entry is a centrally located collection of information regarding the transaction.

In step 606, the central server 100 generates a BOL based on the transaction information 108. The BOL is an electronic document which is stored, maintained, and optionally periodically updated at the central server 100. The BOL is available for viewing or printout by the goods source location 300 (and the other parties to the transaction) via the Web site generated by the central server 100. The goods source location 300 can print the BOL, preferably using the printer 12 associated with the terminal 10 at the goods source location 300. Preferably, the BOL includes a bar code containing the transaction number. A hardcopy version of a BOL is typically transported with the goods by a shipping vehicle.

In step 608, each party that is both involved in the transaction and registered with the central server 100 is notified that the transaction has been registered. A party notification regarding the transaction is generated and can be transmitted to the parties involved in the transaction. The notification can be, for example, via e-mail or via a pop up message at the party's terminal 10 or vehicle terminal 464, such as via visual and audible notification appearing on a vehicle terminal 464. In alternate embodiments, the parties need not be notified of events such as the creation of a transaction. The notification from the central server 100 to the carrier 400 regarding the new transaction can include details on the shipment allowing the carrier 400 to fulfil the order, or alternatively such details can be accessed by the carrier 400 via the central server Web site. In response to the notification, parties can log on to the central server 100 and view, update or add to information regarding the transaction.

In step 610, the carrier 400 can assign a vehicle 450 to the shipment. For example, in response to a transaction notification the carrier may decide which vehicle 450 is to participate in the transaction. The carrier may make such a decision aided by the position tracking capabilities of the central server 100. The carrier 400 may add information identifying the vehicle 450 to the transaction information 108.

The carrier 400 communicates with one of the vehicles 450 associated with the carrier 400, notifying the vehicle 450 that the vehicle 450 is involved with the shipping transaction and of the details of the transaction. Alternately, the vehicle 450 may be notified of the transaction information directly via the central server 100. Such details can include the transaction number, the identities and locations of the source 200 and destination 500, and relevant contact information. This communication can be via text or other messaging utilizing the central server 100, the Internet 4, and the vehicle terminal 464, or alternately directly between the carrier 400 and the vehicle 450 via conventional methods, such as radio, cellular telephone, or satellite communication. The notification to the vehicle 450 can include or reference the BOL.

While in some embodiments, at the time that an arrangement between a carrier 400 and source 200 is made, a vehicle 450 is not specified, in alternate good embodiments, a particular vehicle 450 may be specified as part of such an arrangement. The carrier 400 may communicate the identity of the vehicle 450 assigned to the transaction to the central server 100, which adds this information to a transaction record in the transaction information 108 portion of the databases 102. The other parties to the transaction may be notified of this information or, alternatively, view this information at any time by accessing the central server 100.

In step 612, the central server 100 activates its tracking of the assigned vehicle 450 using the GPS unit 462 of the assigned vehicle 450, and transmits a GPS activation message to the vehicle processor 460. Periodically, for example every fifteen minutes, vehicle processor 460 uses its vehicle GPS unit 462 to determine the vehicle location and transmits this location information to the central server 100. To determine its location, the GPS unit 462 uses known methods, receiving location information from the GPS satellites 20 and calculating its geographic position. In alternate embodiments, the vehicle 450 location may be determined by the central server 100 periodically polling the vehicle processor 460.

In step 614, the vehicle 450 proceeds to the goods source location 300, for example a warehouse or a site controlled by or associated with a supplier. Preferably, the goods source location 300 has been notified of the transaction in step 608; the notification to the goods source location 300 may include, for example, instructions to release the load of goods. In one example of a transaction which can be facilitated by an embodiment of the system and method of the present invention, the goods source location 300 is a warehouse not associated with the source 200. Such a third party warehouse may not be registered with the central server 100. In such a case the warehouse is advised of the transaction and pickup via conventional means; e.g., telephone, facsimile or e-mail.

In step 616 as the vehicle 450 moves to the goods source location 300 and then to the destination 500, any party which is registered with the central server 100 and which is a party to the transaction may track the location of the vehicle 450 via the Web interface provided by the central server 100. Preferably, only parties which are participating in the transaction may track the location of the vehicle 450 via the central server 100. Such location monitoring can be conducted at any time during the shipping transaction.

In one advantageous embodiment, the central server 100 includes software and database information creating a route list or map showing a planned route for the vehicle 450 when travelling to its pick-up and drop-off sites. Such software may also calculate an estimated time of arrival (“ETA”) for the vehicle 450 at the pick-up site to be calculated. The use of such map and route software is known. The resulting map or route may be transmitted to the vehicle 450. The generation of a route list, map or ETA may be accomplished using an affiliate having software separate from the central server 100. Alternately, the parties to the transaction can use the vehicle location information to generate an ETA for the vehicle 450. That the parties to the shipping transaction document and monitor the transaction and track the vehicle location easily and efficiently reduces delay and paperwork. Furthermore, accurate and up-to-date vehicle location information may allow a goods source location 300 to stage goods for pickup more efficiently.

In step 618, possibly based on the ETA, the goods source location 300 may assign a loading dock and assign a time at which the load to be shipped will be waiting on the loading dock. The goods source location 300 communicates the loading dock and time to the central server 100 using the goods source location terminal 10 and the Web interface generated by the Web server 104. The central server 100 adds this information to the transaction record in the transaction information 108 portion of the databases 102. The carrier 400 or vehicle 450 can access the central server 100 to determine the assigned loading dock and the time at which the goods are to be available. The vehicle 450 can schedule its arrival at the goods source location 300 accordingly. In an alternate embodiment of the system and method of the present invention, the goods source location 300 may simply notify the central server 100 when the goods are ready for pickup, and the central server 100 in turn may notify other parties regarding the goods availability or make available information regarding the goods availability.

In step 620, at the proper time, the goods source location 300 stages the order, gathering the shipment and properly placing the shipment on the loading dock.

In step 622, the vehicle 450 arrives at the goods source location 300 to pick up the load. When the vehicle 450 picks up the goods, its operator is given a paper version of the BOL. The goods source location 300 can print the BOL, preferably using the printer 12 associated with the terminal 10 at the goods source location 300.

The operator of the vehicle 450 electronically signs the electronic copy of the BOL which is stored at the central server 100, indicating the order has been picked up. The electronic signature is transmitted to the central server 100, indicating a pickup; the transaction record may be updated accordingly. To sign the electronic copy of the BOL, preferably the vehicle terminal 464 first displays the BOL on the display 470. After logging in to the central server 100, the record for the transaction is accessed, advantageously by mandatory entering of the transaction number. For instance, the transaction number is entered by scanning the bar code containing the transaction number, which can be printed on the paper copy of the BOL; in such an embodiment, the vehicle terminal 464 or the terminal 10 at the goods source location 300 can include a known bar code reader.

The operator of the vehicle 450 views the displayed BOL and signs it electronically using the vehicle terminal data entry interface 472 or the terminal 10 at the goods source location 300. In a good embodiment where that the data entry interface 472 includes an alphanumeric or other typical keyboard the operator may sign the BOL by entering a digital signature which is a code or PIN. Preferably, for security purposes, knowledge of the code or PIN is restricted, for example, being known only by the operator and the central server 100. In a further embodiment, where the data entry interface 472 or the terminal 10 at the goods source location 300 includes a known handwriting (e.g., signature) entry interface, the operator may sign using a pen, such that a handwritten signature is electronically captured and recorded by the vehicle terminal 464 or the terminal 10 and transmitted to the central server 100. The central server 100 records the handwritten signature using known methods, and may verify the signature. The pen may use conventional pressure sensitive or other technologies. In addition, such a pen may use a link adhering to the Bluetooth technology specification to communicate with either the vehicle terminal 464 vehicle processor 460.

Other technologies can also be used, such as a digital signature which is a series of bytes used to hash or encode an electronic version of the BOL, or which constitute an encryption key, or signature involving biometric entry, such as fingerprint entry.

In step 624, the central server 100 records the time and date of the shipment pickup. The status of the transaction as stored by the central server 100 is changed to indicate the goods have been picked up. Preferably, the central server 100 provides each of the parties with a pickup notification. As with other notifications, the pickup notification can be via e-mail, via text messaging, or via other methods. Alternately, it can be made a pre-requisite of accessing the notification of pickup or other events that a party log on to the central server 100 and request information on a specific transaction.

In step 626, the vehicle 450 proceeds with the load to the destination 500 which may be, for example, a consignee separate from the source 200. The position of the vehicle 450 is tracked by the central server 100 and is accessible by parties to the transaction.

In step 628, when the vehicle 450 reaches the destination 500, the load is unloaded and delivered.

In step 630, the POD is executed. Traditionally, to execute a POD document, the receiving party signs the paper constituting the BOL. The POD document can then be used by the carrier 400 to receive payment from the party who ordered the shipment; e.g. the source 200 or destination 500, a third party freight forwarder, or from a factoring agent. The system and method of the present invention allow for efficient electronic creation of a POD document or other POD information with a minimum of delay and effort. To sign the BOL, which is stored at the central server 100, preferably, the vehicle terminal 464 first displays the BOL on the display 470. After logging in to the central server 100, the record for the transaction is accessed, advantageously by mandatory entering of the transaction number.

For instance, the transaction number is entered by scanning the bar code containing the transaction number; in such an embodiment, the vehicle terminal 464 or the terminal 10 at the destination 500 can include a known bar code reader.

The receiving party views the displayed BOL and signs it electronically using the vehicle terminal data entry interface 472 or the terminal 10 at the destination 500, in a manner similar to that discussed above, with respect to the signing on pick up.

In step 632, when the POD signature is transmitted to the central server 100, the BOL stored at the central server 100 is updated and marked as a POD document. The status of the transaction as stored by the central server 100 is changed to indicate the goods have been delivered. In alternate embodiments POD may be recorded and stored in other forms; for example, POD using a BOL need not be used.

In step 634, all parties to the transaction are notified of the successful delivery. The POD document or other POD information is immediately electronically accessible by the carrier 400. The POD document or other POD information can then be forwarded to a factor agent for payment. Alternately, if a factor agent has an account with, an affiliate arrangement with, or is otherwise associated with or connected to the central server 100, the POD may be immediately forwarded to the factor agent for payment. Thus payment by the factor is speeded up. The operator of the vehicle 450 is not required to deliver a paper POD to the carrier 400 or a factoring agent by mail, courier, or facsimile. Additionally, the delivery notification can be utilized by other parties to the transaction as a basis for exchange funds between them. In some good embodiments, the central server 100 may facilitate other payments as well.

Of course, in alternate embodiments, the groupings of system components, and sequences of method steps disclosed in FIGS. 4a, 4b and 4c and their explanations, can be varied as long as the essential features of the invention are preserved.

Thus, while certain embodiments of the system and method of the present invention are described and shown specifically, there is no intention of limiting the present invention to only those embodiments, since variations and equivalents of the invention will be apparent to those skilled in the art once in possession of their disclosure. It should be noted that the present invention may be implemented in different manners and used for different applications. For example, while a sample transaction is described where a supplier or source initiates the transaction and hires a carrier, a destination or consignee may also use the system and method of the present invention to initiate and track a shipment operation from a source to a destination. Other shipping documents may be generated, stored, updated and tracked using the system and method of the present invention, such as export declarations or documents, foreign bill of lading documents (e.g., a Mexican Orden de Remision), commercial invoices, NAFTA certificates of origin, or other documents. In other embodiments, not every party participating in a shipping transaction need be registered with or a member of the system.

What is claimed is:

1. A system for facilitating a multi party shipping transaction, such transaction involving transport by a vehicle of a load of goods from a first facility to a second facility on behalf of a party in interest, the system comprising:
a central site connected to an electronic network, the central site including a database, the database including:
a record for a sending party;
a record for a receiving party; and
a record for a shipping party; and
the central site capable of:
collecting location information regarding a load of goods;
creating a bill of lading for the load of goods;
making available the location information for access by at least one of said parties via the electronic network;
making available the bill of lading for access by at least one of said parties via the electronic network; and
collecting proof of delivery information.

2. The system of claim 1 wherein the central site is capable of collecting proof of delivery information in the form of a digital signature.

3. The system of claim 1 wherein the central site is capable of collecting proof of delivery information in the form of a code.

4. The system of claim 1 wherein the central site is capable of collecting proof of delivery information in the form of an electronically captured handwritten signature.

5. The system of claim 1 wherein the central site includes a Web site permitting a shipping party and the first facility to have access to the bill of lading.

6. The system of claim 1 wherein the location information is generated with a GPS device.

7. The system of claim 1 wherein the central site is accessible by the first facility and said party in interest via an electronic network.

8. The system of claim 7 wherein the electronic network is the Internet.

9. A system for facilitating a multi-party shipping transaction, the system comprising:
a centralized shipping transaction processor;
a set of data terminals each configured to communicate with at least the shipping transaction processor via a network; and
an on-board information manager arranged on a vehicle, wherein the information manager is adapted to communicate with at least the centralized shipping transaction processor throughout the course of the transaction.

10. The system of claim 9 wherein the shipping transaction processor further comprises:
a CPU;
a storage device to store shipping transaction data; and
a communications device adapted to communicate with the data terminals.

11. The system of claim 9 wherein the shipping transaction processor is capable of collecting proof of delivery information in the form of a digital signature.

12. The system of claim 9 wherein the shipping transaction processor is capable of collecting proof of delivery information in the form of a code.

13. The system of claim 9 wherein the shipping transaction processor is capable of collecting proof of delivery information in the form of an electronically captured handwritten signature.

14. The system of claim 9 wherein the shipping transaction processor generates a bill of lading, and the bill of lading includes a Web site permitting a shipping party and the first facility to have access to the bill of lading.

15. The system of claim 9 wherein the location information is generated with a GPS device.

16. The system of claim 9 wherein the network is the Internet.

17. A method of facilitating a multi-party shipping transaction via a central site, such transaction involving transport by a vehicle of a load of goods from a first facility to a second facility on behalf of a party in interest, the method comprising:
collecting at the central site information transmitted from the vehicle describing the location of the vehicle;
permitting the first facility to have access to, via the central site, information describing the location of the vehicle;
creating an electronic bill of lading;
collecting pickup notification at the central site once the vehicle receives the load from the first facility;
collecting proof of delivery information at the central site once the vehicle delivers the load to the delivery site; and
permitting said party in interest to have access, via the central site, to information concerning the location of the vehicle, to the status of collection of said pickup notification, and to the status of receipt of said proof of delivery information.

18. The method of claim 17 wherein the step of collecting proof of delivery includes the collection of a digital signature.

19. The method of claim 18 wherein the digital signature is a code.

20. The method of claim 18 wherein the digital signature is an electronically captured handwritten signature.

21. The method of claim 17 further comprising permitting a carrier and the first facility to have access, via the central site, to the bill of lading.

22. The method of claim 17 wherein the location information is determined using a GPS device.

23. The method of claim 17 wherein the step of collecting information describing the location of the vehicle is performed periodically.

24. The method of claim 17 wherein the central site is accessible by the first facility and said party in interest via an electronic network.

25. The method of claim 24 wherein the electronic network comprises the Internet.

26. A method of facilitating multi-party shipping transaction, the method comprising:
electronically generating a bill of lading, such that the bill of lading can be accessed by the parties to the transaction;
electronically notifying a storage facility of a sending party's instruction that an outgoing load be released from the facility for delivery;
electronically notifying a carrier that the load is available for pickup; collecting information about the order throughout the course of the transaction;
electronically capturing the consignee's acceptance of the delivery; and
making the information about the order electronically accessible by the parties throughout course of the transaction.

27. The method of claim 26 comprising collecting proof of delivery.

28. The method of claim 26 wherein a vehicle ships the load, the method comprising:
tracking the location of the vehicle; and
making information on the location available to the parties.

29. A method of facilitating the transportation of a load of goods by a vehicle between a first facility and a second facility, the method comprising:
transmitting from said vehicle information describing the location of said vehicle for posting at a central site;
presenting said vehicle at said first facility pursuant to notification, related to the location of said vehicle, that said load of goods awaits pick-up there, such notification being the result of posting at said central site of information regarding the transportation;
after pick-up of said load of goods by said vehicle, transmitting from said vehicle information describing the location of said vehicle for posting at said central site, from which information regarding an estimated time of arrival of said vehicle at said second facility can be determined;
securing proof of delivery information, signifying delivery of said load of goods at said second facility, said proof of delivery information being in electronic form suitable for transmission to said central site for posting; and
obtaining payment for transport of said load of goods based on the proof of delivery information posted at said central site.

30. The method of claim 29 wherein the step of securing proof of delivery includes the collection of a digital signature.

31. The method of claim 30 wherein the digital signature is a code.

32. The method of claim 30 wherein the digital signature is an electronically captured handwritten signature.

33. The method of claim 29 wherein the location information is determined using a GPS device.

34. The method of claim 29 wherein said vehicle accesses the central site via a radio link and the Internet.

35. A method of facilitating the transfer of a load of goods from a first facility to a second facility, the method comprising:
accessing a central site presenting information concerning the location of vehicles available for transporting said load of goods;
transmitting to said central site information describing the transfer;
transmitting information resulting in the notification of one or more of said vehicles that it should pick up said load of goods at said first facility;
after pick-up of said load of goods by said vehicle, accessing said central site to obtain information concerning the location of said vehicle to monitor when delivery of said load of goods will occur; and
accessing said central site for proof of delivery information posted at said site concerning said load of goods.

36. The method of claim 35 further comprising accessing, via said central site, the bill of lading.

37. The method of claim 35 further comprising accessing said central site via the Internet.

38. A method of facilitating the receipt at a second facility of a load of goods from a first facility, the method comprising:
accessing a central site for information concerning the location of a vehicle carrying said load of goods;
coordinating preparation to receive the load of goods at said second facility with the arrival of said vehicle as indicated by said information;
and providing proof of delivery information in electronic form for collection at said central site.

39. The method of claim 38 further comprising accessing the central site via the Internet.
